(19) United States
(12) Patent Application Publication
(10) Pub. No.: US 2025/0117352 A1
(43) Pub. Date: Apr. 10, 2025

(54) ACCELERATION UNIT WITH MODULAR ARCHITECTURE

(71) Applicant: ADVANCED MICRO DEVICES, INC., Santa Clara, CA (US)

(72) Inventors: Alan D. Smith, Austin, TX (US); Michael Mantor, Orlando, FL (US); Mark Fowler, Boxborough, MA (US); Vydhyanathan Kalyanasundharam, Santa Clara, CA (US); Samuel Naffziger, Ft. Collins, CO (US)

(21) Appl. No.: 18/910,202

(22) Filed: Oct. 9, 2024

Related U.S. Application Data
(60) Provisional application No. 63/543,281, filed on Oct. 9, 2023.

(51) Int. Cl. G06F 13/40; G06F 9/50; G06F 12/0893

(52) U.S. Cl. CPC G06F 13/409; G06F 9/5027; G06F 12/0893; G06F 2212/305

(57) ABSTRACT

A processing system includes one or more accelerator units (AUs) each having a modular architecture. To this end, each AU includes a connection circuitry and one or more memory stacks disposed on the connection circuitry. Further, each AU includes one or more interposer dies each disposed on the connection circuitry such that each interposer die of the one or more interposer dies is communicatively coupled to a corresponding memory stack of the memory stacks via the connection circuitry. Further, each interposer die of each AU includes circuitry configured to concurrently support two or more types of compute dies.

### BACKGROUND

To execute applications, some processing systems include multiple processing devices such as central processing units (CPUs), graphics processing units (GPUs), and the like that execute instructions, perform operations, or both on behalf of these applications. Many of these processing devices include one or more dies that have processor cores configured to execute the instructions. These dies are disposed on a silicon interposer configured to connect the processor cores on the dies to other components of a processing system such as a host device or memory. However, these silicon interposers are often configured to only support a set number of dies, limiting the types of instructions and operations the processing device is configured to execute and limiting the flexibility of the processing device. Further, many of these silicon interposers are configured to only support a certain type of die, again limiting the types of instructions and operations the processing device is configured to execute and the flexibility of the processing device.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram illustrating a processing system that includes accelerator units (AUs) having a modular architecture, in accordance with some implementations.

FIG. 2 is a block diagram illustrating an active interposer die (AID) configured to concurrently support one or more compute dies, in accordance with some implementations.

FIG. 3 is a block diagram illustrating an example core complex die (CCD), in accordance with some implementations.

FIG. 4 is a block diagram illustrating an example accelerated core die (AD), in accordance with some implementations.

FIG. 5 is a block diagram illustrating an example architecture for an AID, in accordance with some implementations.

FIG. 6 is a block diagram illustrating an example AU having a modular architecture, in accordance with some implementations.

FIG. 7 is a block diagram illustrating an example architecture for two or more interconnected AUs, in accordance with some implementations.

FIG. 8 is a block diagram illustrating an example AU configured to support two or more types of core dies, in accordance with some implementations.

FIG. 9 is a block diagram illustrating an example operation for partitioning an AU having a modular architecture, in accordance with some implementations.

FIGS. 10 to 12 are each block diagrams illustrating respective partitioning schemes, in accordance with some implementations.

FIGS. 13 to 17 are each block diagrams illustrating respective example architectures of an AU, in accordance with some implementations.

### DETAILED DESCRIPTION

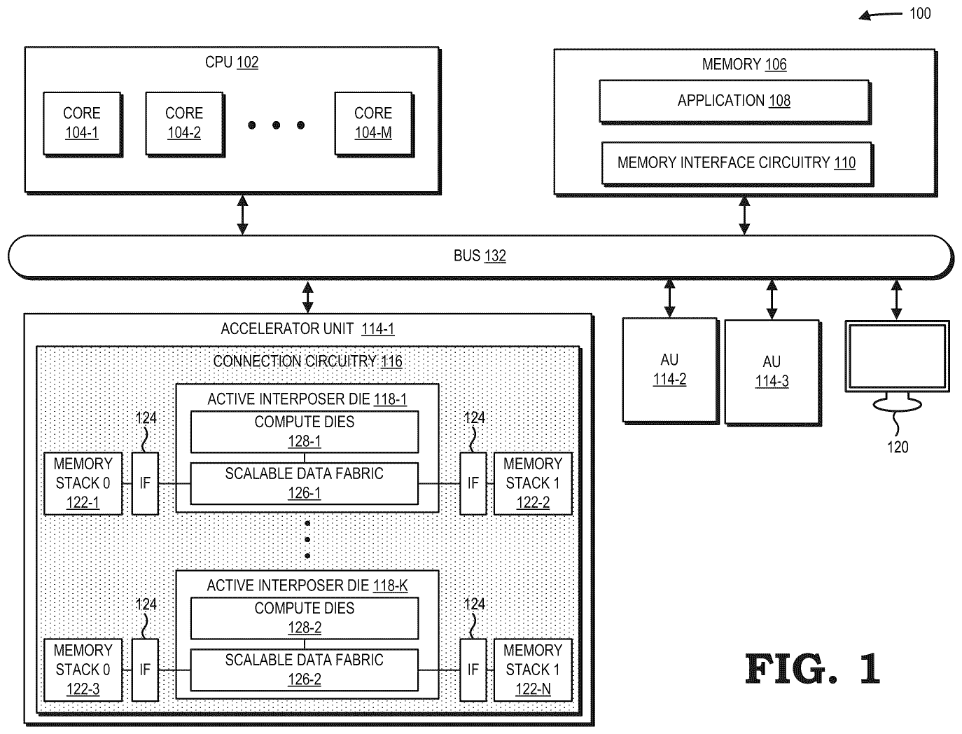

Herein, FIGS. 1 to 17 are directed to a processing system that includes an accelerator unit (AU) with a modular architecture. Such a processing system, for example, is configured to execute one or more applications such as high-performance compute (HPC) applications, graphics applications, or both. HPC applications, for example, include resource-intensive applications that include machine-learning applications, neural network applications, artificial intelligence applications, and the like. To execute instructions and operations for these applications, the processing system includes one or more AUs each having a modular architecture. This modular architecture of an AU, for example, includes a connection circuitry implemented as a die. Further, the modular architecture includes one or more memory stacks disposed on the connection circuitry. Such memory stacks, for example, include a three-dimensional (3D) stacked memory having one or more memory layers. Additionally, the modular architecture includes one or more active interposer dies (AIDs) disposed on the connection circuitry such that each AID is communicatively coupled to one or more of the memory stacks via the connection circuitry. The AIDs are further disposed on the connection circuitry such that each AID is communicatively coupled to each other AID disposed on the connection circuitry.

To execute instructions and operations for one or more applications, each AID of an AU is configured to concurrently support one or more compute dies. That is to say, one or more compute dies are configured to be disposed on each AID. A compute die, for example, includes one or more chiplets that each include processor cores, compute units, or both configured to execute one or more instructions, operations, or both for one or more applications. To support these compute dies, each AID includes a scalable data fabric configured to communicatively couple each compute die supported by the AID to one or more memory stacks (e.g., via the connection circuitry), one or more other compute dies also supported by the same AID, or both. In this way, each AID of an AU is enabled to have any number of compute dies, allowing for the AU to have different combinations of compute dies with which to execute one or more instructions, operations, or both for one or more applications being executed by the processing system.

Further, each AID is configured to concurrently support two or more types of compute die. As an example, an AID is configured to support both core complex dies (CCDs) that include chiplets having one or more processor cores operating as compute units and accelerated dies (ADs) that include chiplets having one or more compute units (e.g., hardware-based compute units) and one or more accelerators. Such accelerators include, for example, hardware-based accelerators, FPGA-based accelerations, asynchronous compute circuitry, or any combination thereof to name a few. To support these different types of core dies, the scalable data fabric of an AID includes a respective set of circuitry to support each corresponding type of core die. For example, the scalable data fabric of an AID includes a first set of circuitry configured to communicatively couple one or more CCDs to one or more memory stacks so as to maintain cache coherency across the CCDs and a second set of circuitry configured to communicatively couple one or more ADs to one or more memory stacks so as to maintain graphics coherency across the ADs. In this way, each AID of an AU is enabled to have any number of compute dies of multiple types, allowing for the AU to have a greater number of combinations of compute dies with which to execute one or more instructions, operations, or both for one or more applications being executed by the processing system.

FIG. 1 is a block diagram of a processing system 100 including AUs having a modular architecture, in accordance with some implementations. In implementations, processing system 100 includes one or more servers, databases, cloud-based devices, personal computers, laptops, drones, mobile devices, or the like and includes or has access to memory 106 or another storage component implemented using a non-transitory computer-readable medium, for example, a dynamic random-access memory (DRAM). However, in implementations, memory 106 is implemented using other types of memory including, for example, static random-access memory (SRAM), nonvolatile RAM, and the like. According to implementations, memory 106 includes an external memory implemented external to the processing units (e.g., CPU 102, AUs 114) implemented in the processing system 100. Memory 106, in some implementations, includes memory interface circuitry 110 configured to communicate with one or more components of processing system 100 (e.g., CPU 102, AUs 114) using one or more communication protocols (e.g., Compute Express Link (CXL) 1.0, CXL 1.1, CXL 2.0, peripheral component interconnect express (PCIe)). That is to say, memory interface circuitry 110 provides an interface for communication between memory 106 and one or more components of processing system 100 using one or more communication protocols. The processing system 100 also includes a bus 132 to support communication between components (e.g., CPU 102, AUs 114, memory 106) implemented in the processing system 100. Some implementations of processing system 100 include other buses, bridges, switches, routers, and the like, which are not shown in FIG. 1 in the interest of clarity. For example, in some implementations, processing system 100 includes a data fabric including bus 132 and configured to support communication between the components of processing system 100.

According to implementations, processing system 100 is configured to execute one or more applications 108. Such applications 108, for example, include compute applications, graphics applications, machine-learning applications, neural network applications, artificial intelligence applications, HPC applications, or any combination thereof, to name a few. In some implementations, certain applications 108 (e.g., compute applications, machine-learning applications, neural-network applications, artificial intelligence applications, HPC applications), when executed by processing system 100, causes processing system 100 to perform one or more computations, for example, machine-learning computations, neural network computations, databasing computations, sequencing computations, modeling computations, forecasting computations, or the like. Further, graphics applications, when executed by processing system 100, causes processing system 100 to render a scene including one or more graphics objects within a screen space and, for example, display them on a display 120.

To help execute one or more applications 108, processing system 100 includes one or more AUs 114 each having a modular architecture. An AU 114, for example, is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., FPGAs), or any combination thereof. In implementations, an AU 114 performs one or more commands, instructions, draw calls, or any combination thereof indicated in an application 108. For example, for certain applications such as compute applications, machine-learning applications, neural network applications, artificial intelligence applications, HPC applications, and the like, an AU 114 performs one or more commands, instructions, draw calls, or any combination thereof so as to generate one or more results for one or more computations (e.g., machine-learning computations, neural network computations, databasing computations, sequencing computations, modeling computations, forecasting computations). As another example, for graphics applications, an AU 114 performs one or more commands, instructions, draw calls, or any combination thereof so as to render images according to one or more graphics applications for presentation on display 120. To this end, AU 114 renders graphics objects (e.g., groups of primitives) to produce values of pixels that are provided to display 120 which uses the pixel values to display an image that represents the rendered graphics objects. Though the example implementation illustrated in FIG. 1 presents processing system 100 as including three AUs (114-1, 114-2 114-3), in other implementations, processing system 100 can include any number of AUs.

To help perform commands, instructions, draw calls, or any combination thereof for one or more applications 108, each AU 114 includes a modular architecture that includes connection circuitry 116. Connection circuitry 116, for example, includes one or more dies, data fabrics, busses, ports, traces, interleavers, or any combination thereof configured to connect one or more elements (e.g., memory stacks 122, AIDs 118) of AU 114 to one or more other elements (e.g., memory stacks 122, AIDs 118) of AU 114. Further, each AU 114 includes one or more memory stacks 122 disposed on and communicatively coupled to connection circuitry 116. Each memory stack 122, for example, includes a 3D stacked memory (e.g., synchronous dynamic random-access memory (SDRAM)) having one or more memory layers that each have one or more memory banks, memory subbanks, or both. Additionally, each memory stack 122 includes an interface, represented in FIG. 1 as IF 124, that includes circuitry configured to communicatively couple the memory stack 122 to connection circuitry 116, one or more elements of AU 114 (e.g., AIDs 118), or both. In implementations, each IF 124 includes a High Bandwidth Memory (HBM) interface, a second-generation High Bandwidth Memory (HBM2) interface, a third-generation High Bandwidth Memory (HBM3) interface, or the like. Though the example implementation presented in FIG. 1 shows AU 114-1 as having four memory stacks (122-1, 122-2, 122-3, 122-N) representing an N integer number of memory stacks, in other implementations, each AU 114 may have any non-zero integer number of memory stacks. For example, in some implementations, one or more AUs 114 have a first number of memory stacks 122 (e.g., the same number of memory stacks 122), and one or more other AUs 114 have a second number of memory stacks 122 that is different from the first number of memory stacks 122.

According to implementations, each AU 114 also includes one or more AIDs 118 disposed on connection circuitry 116. An AID 118, for example, includes a die configured to support one or more compute dies 128. A compute die 128, for example, includes a die having one or more processor cores, compute units, caches, or any combination thereof. For example, a compute die 128 includes a die having one or more chiplets disposed thereon that include one or more processor cores operating as compute units and one or more caches communicatively coupled to the processor cores. In some implementations, one or more compute dies 128 are configured to be disposed on an AID 118 while, in other implementations, the circuitry forming one or more compute dies 128 is included within an AID 118. Each compute unit, for example, is configured to perform one or more operations for one or more applications 108 being executed by processing system 100. For example, the compute units of a compute die 128 are configured to execute operations for applications 108 concurrently or in parallel. In some implementations, one or more compute units include single instruction multiple data (SIMD) units that perform the same operation on different data sets. As an example, one or more compute cores include SIMD units that perform the same operation as indicated by one or more commands, instructions, or both from an application 108. According to implementations, after performing one or more operations for an application 108, a SIMD unit stores the data resulting from the performance of the operation (e.g., the results) in a cache of the compute die 128, memory 106, a memory stack 122, or any combination thereof.

To help each compute die 128 of an AID 118 perform one or more instructions, operations, or both for an application 108, each AID 118 includes a scalable data fabric 126 that includes circuitry configured to communicatively couple the processor cores (e.g., compute units) of each compute die 128 disposed on the AID 118 to one another. As an example, referring to the example implementation presented in FIG. 1, scalable data fabric 126-1 is configured to communicatively couple the processor cores (e.g., compute units) of compute dies 128-1 to one another. Additionally, the scalable data fabric 126 of each AID 118 is configured to communicatively couple the compute dies 128 disposed on the AID 118 to one or more memory stacks 122, one or more other AIDs 118 (e.g., the compute dies 128 disposed on the other AIDs 118), or both. As an example, each scalable data fabric 126 includes circuitry configured to communicatively couple the compute dies 128 disposed on the AID 118 to one or more memory stacks 122, one or more other AIDs 118, or both using one or more communication protocols. Additionally, in implementations, each scalable data fabric 126 includes circuitry configured to communicatively couple the compute dies 128 disposed on the AID 118 to one or more memory stacks 122, one or more other AIDs 118, or both via connection circuitry 116. That is to say, the scalable data fabric 126 of an AID 118 is configured to communicatively couple the compute dies 128 of the AID 118 to connection circuitry 116 which, in turn, communicatively couples the compute dies 128 of the AID 118 to one or more memory stacks 122, one or more other AIDs 118, or both. Though the example implementation presented in FIG. 1 shows AU 114-1 as including two AIDs 118 representing a K integer number of AIDs 118, in other implementations, AU 114 can include any non-zero integer number of AIDs 118. As an example, in some implementations, AU 114 includes four AIDs 118 each disposed on and communicatively coupled to connection circuitry 116. Further, although the example implementation presented in FIG. 1 shows the scalable data fabric (126-1, 126-2) of each AID 118 connecting respective compute dies 128-1, 128-2 to two memory stacks 122, in other implementations, the scalable data fabric (126-1, 126-2) of each AID 118 can connect respective compute dies 128 to any non-zero integer number of memory stacks 122.

According to implementations, each AID 118 is configured to support one or more types of compute dies 128. For example, in some implementations, AID 118 is configured to support one or more CCDs and one or more ADs. Such CCDs, for example, include a die having one or more core chiplets that include one or more pairs of processor cores operating as one or more compute units and one or more caches. As an example, a CCD includes a number of processor cores each operating as compute units that are communicatively coupled to each other by one or more caches. An AD, for example, includes a die having one or more chiplets (e.g., accelerated complexes (ACs)) each including one or more compute units (e.g., hardware-based compute units) and one or more accelerators. Such accelerators include, for example, hardware-based accelerators, FPGA-based accelerations, asynchronous compute circuitry, or any combination thereof to name a few. Such asynchronous compute circuitry, for example, is configured to assign operations, tasks, or both to compute units so as to allow for order-independent execution. For example, asynchronous compute circuitry is configured to assign operations to the compute units of an AC such that the compute units of the AC call a routine, task, operation, or any combination thereof in a pipeline before one or more preceding routines, tasks, or operations (e.g., routines, tasks, operations coming before the called routine, task, or operation in the pipeline) are returned.

To support one or more types of compute dies 128, the scalable data fabric 126 of an AID 118 includes sets of circuitry each configured to support a corresponding type of compute die 128. For example, to support a CCD, the scalable data fabric 126 of an AID 118 includes a first set of circuitry configured to communicatively couple the processor cores of the CCD together, communicatively the CCD to one or more other compute dies disposed on the AID 118, communicatively couple the processor cores of the CCD to one or more memory stacks 122, or any combination thereof using one or more communication protocols. As an example, to support a CCD, a scalable data fabric 126 includes or is otherwise connected to a respective cache (e.g., memory-attached last level cache (MALL)) for one or more processor cores of a CDD, one or more instances of cache coherency management circuitry, or both. As another example, to support an AD, the scalable data fabric 126 of an AID 118 includes a second set of circuitry configured to communicatively couple the compute units of the AD together, communicatively couple the AD to one or more other compute dies 128 disposed on the AID 118, communicatively couple the compute units of the AD to one or more memory stacks 122, or any combination thereof using one or more communication protocols. For example, to support an AD, a scalable data fabric 126 includes or is otherwise connected to a respective cache (e.g., MALL) for one or more compute units of an AD, one or more instances of graphics management circuitry, one or more subnetworks, or any combination thereof. In implementations, as an example, to support an AD, a scalable data fabric 126 includes a subnetwork configured to communicatively couple each compute unit of the AD to each other and each compute unit of the AD to address translation circuitry, memory access management circuitry, hardware accelerators (e.g., hardware encoders, hardware decoders), multimedia circuitry, or any combination thereof. According to some implementations, one or more AIDs 118 are configured to concurrently support a first compute die 128 of a first type (e.g., CCD) while supporting a second compute die 128 of a second type (e.g., AD) different from the first type. In some implementations, the first set of circuitry of scalable data fabric 126 configured to support a first type of compute die 128 is distinct from the second set of circuitry of scalable data fabric 126 configured to support a second type of compute die 128 while in other embodiments the first set of circuitry of scalable data fabric 126 configured to support a first type of compute die 128 is included within the second set of circuitry of scalable data fabric 126 configured to support a second type of compute die 128.

Additionally, in implementations, the scalable data fabric 126 of an AID 118 is configured to communicatively couple the AU 114 including the AID 118 to one or more other AUs 114 of processing system 100. To this end, according to implementations, a scalable data fabric 126 of an AID 118 includes interconnection circuitry configured to communicatively couple the AU 114 to one or devices using one or more communication protocols (e.g., CXL, PCIe, universal serial bus (USB)). For example, a scalable data fabric 126 includes interconnection circuitry configured to communicatively couple the AU 114 to one or other AUs 114 of processing system 100 using one or more communication protocols. According to implementations, the scalable data fabric 126 of an AID 118 is configured to communicatively couple the AU 114 to one or more other AUs 114 such that one or more compute dies 128, memory stacks 122, or both of the AU 114 are communicatively coupled to one or more compute dies 128, memory stacks 122, or both of the one or more other AUs 114.

Processing system 100, in some implementations, is configured to partition one or more resources (e.g., compute dies 128, memory stacks 122) of an AU 114 into one or more partitions. For example, processing system 100 is configured to partition the resources of an AU 114 into one or more partitions and then assign each partition to a respective application 108 being executed by processing system 100. As an example, in some implementations, processing system 100 is configured to partition the compute dies 128 into partitions of two compute dies 128 and then assign each partition of two compute dies 128 to a corresponding application 108 being executed. As another example, according to some implementations, processing system 100 is configured to partition the memory stacks 122 of an AU 114 into partitions of four memory stacks 122 and then assign each partition of four memory stacks 122 to a corresponding application 108 being executed. As yet another example, in some implementations, processing system 100 is configured to partition the compute dies 128 and memory stacks 122 into partitions each including one compute die and one memory stack 122, and then assign each partition to a respective application 108 being executed. In some implementations, the resources of an AID 118 are included in a single partition including each compute die 128 and memory stack 122 of the AID 118. Processing system 100 is configured to assign such a single partition to one application 108 being executed. To partition resources of an AU 114, processing system 100 includes a hypervisor (not pictured for clarity) configured to edit one or more registers of the AU 114 so as to partition the compute dies 128, memory stack 122, or both of the AU 114.

In some implementations, processing system 100 also includes CPU 102 that is connected to the bus 132 and therefore communicates with the AUs 114 and memory 106 via the bus 132. CPU 102 implements a plurality of processor cores 104-1 to 104-N that execute instructions concurrently or in parallel. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. The processor cores 104 execute instructions such as program code for one or more applications 108 stored in the memory 106, and CPU 102 stores information in a cache, memory 106, or both such as the results of the executed instructions. According to implementations, CPU 102 is implemented in processing system 100 as one or more AUs 114.

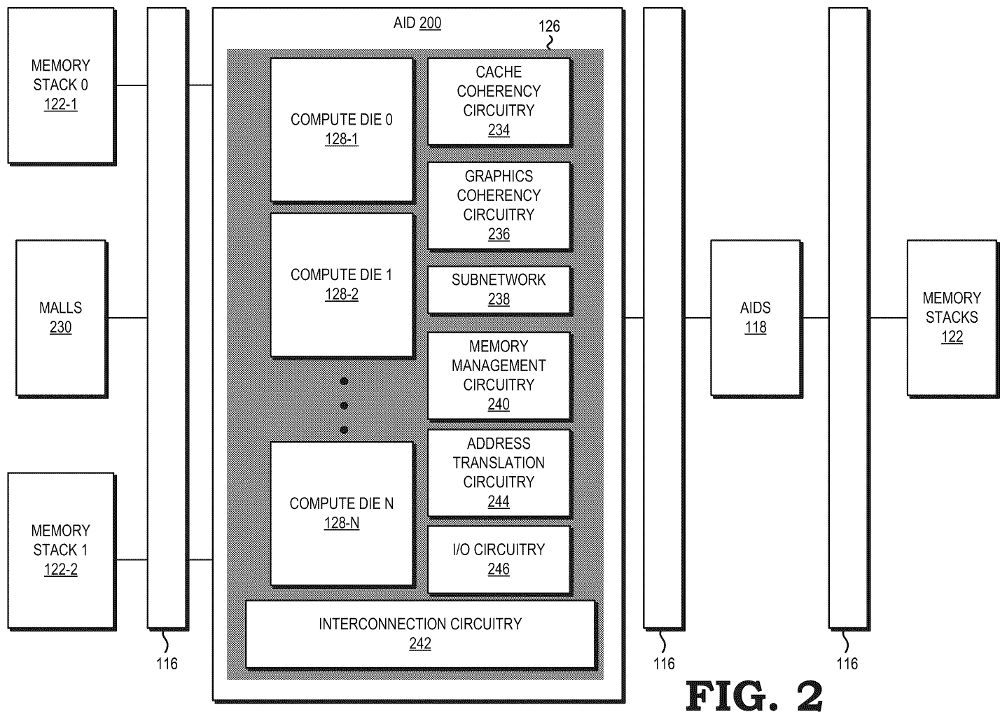

Referring now to FIG. 2, an example AID 200 is presented. In implementations, AID 200 is implemented within processing system 100 as an AID 118 in a respective AU 114. According to implementations, AID 200 is configured to concurrently support two or more compute dies 128 each having a respective type (e.g., CCD, AD). For example, in some implementations, AID 200 is configured to concurrently support a first compute die (e.g., compute die 0 128-1) having a first type (e.g., CCD) and a second compute die (e.g., compute die 1 128-2) having a second type (e.g., AD) different from the first type. Though the example implementation presented in FIG. 2 presents AID 200 as including three compute dies (128-1, 128-2, 128-N) representing an N integer number of compute dies 128, in other implementations, AID 200 can include any non-zero integer number of compute dies 128. To help support compute dies 128, AID 200 includes scalable data fabric 126 that includes circuitry configured to communicatively couple the processor cores of each compute die 128 to one another, the processor cores of each compute die 128 to one or more memory stacks 122, the processor cores of each compute die 128 to one or more other AIDs 118 of the same AU 114, or any combination thereof. Referring to the example implementation presented in FIG. 2, scalable data fabric 126 is configured to communicatively couple one or more compute dies 128 (e.g., one or more processor cores of one or more compute dies 128) to a first memory stack 0 122-1 and a second memory stack 1 122-2 via connection circuitry 116.

According to implementations, AID 200 is configured to communicatively couple the AU 114 including AID 200 to one or more other AUs 114. For example, AID 200 is configured to communicatively couple to one or more AIDs 118 of one or more other AUs 114. To this end, AID 200 includes interconnection circuitry 242 included in or otherwise connected to scalable data fabric 126. Interconnection circuitry 242, for example, is configured to communicatively couple AID 200 to one or other AIDs 118 (e.g., the interconnection circuitry 242 of one or more other AIDs 118) using one or more communication protocols (e.g., CXL, PCIe, USB). Such interconnection circuitry 242 includes, for example, ports (e.g., PCIe ports, USB ports), layers (e.g., PCIe layers, CXL layers, USB layers), traces, wires, and the like configured to communicate couple the compute dies 128 of an AID 200 to the compute dies 128 of one or more other AIDs 118. Further, according to some implementations, AID 200 is configured to communicatively couple to one or more other components of processing system 100 using interconnection circuitry 242. For example, in some implementations, interconnection circuitry 242 is configured to communicatively couple AID 200 to bus 132 using one or more communication protocols (e.g., CXL, PCIe, USB) and then bus 132 communicatively couples AID 200 to one or more components (e.g., CPU 102, memory 106) using the one or more communication protocols. As an example, interconnection circuitry 242 is configured to communicatively couple AID 200 to memory 106 using one or more CXL protocols via bus 132.

Further, AID 200 includes or is otherwise connected to one or more MALLs 230. In implementations, AID 200 is configured to communicatively couple one or more processor cores of one or more compute dies 128, one or more compute units of one or more compute dies 128, or both to a corresponding MALL of MALLs 230. Each MALL 230, for example, is configured to store data used in the execution of one or more operations by one or more compute units of a compute die 128 (e.g., operands, constants, variables, register files), data resulting from the execution of one or more operations by one or more compute units of a compute die 128, or both. According to embodiments, AID 200 also includes I/O circuitry 246 included in or otherwise coupled to scalable data fabric 126. I/O circuitry 246, for example, is communicatively coupled to each compute die 128 and is configured to handle input or output operations associated with the compute dies 128 on the AID 200. As an example, in some implementations, I/O circuitry 246 handles input operations to one or more compute dies 128 of AID 200 received from one or more compute dies 128 of another AU 114 via interconnection circuitry 242. As another example, I/O circuitry 246 handles output operations from one or more compute dies 128 of AID 200 transmitted to one or more compute dies 128 of another AU 114 via interconnection circuitry 242. As yet another example, I/O circuitry 246 is configured to handle input and output operations between AID 200 and one or more other components of processing system 100 via bus 132.

Additionally, AID 200 includes memory management circuitry 240 and address translation circuitry 244 each included in or otherwise connected to scalable data fabric 126. Memory management circuitry 240, for example, is communicatively coupled to each compute die 128 and is configured to handle direct memory access (DMA) requests, memory-mapped input-output (MMIO) requests, or both between each compute die 128 and memory 106, between a first compute die 128 and one or more other compute dies 128, one or more compute dies 128 and one or more AUs 114, or any combination thereof. For example, memory management circuitry 240 includes one or more input/output memory management units (IOMMUs), translation look-aside buffers (TLBs), or both configured to handle DMA requests, MMIO requests, or both between each compute die 128 and memory 106, between a first compute die 128 and one or more other compute dies 128, one or more compute dies 128 and one or more AUs 114, or any combination thereof. Address translation circuitry 244, for example, is communicatively coupled to each compute die 128 and is configured to provide address translation for memory access requests (e.g., DMA requests, MMIO requests) between each compute die 128 and memory 106, between a first compute die 128 and one or more other compute dies 128, one or more compute dies 128 and one or more AUs 114, or any combination thereof. For example, in some implementations, address translation circuitry 244 includes or otherwise has access to a set of page tables that include data (e.g., page table entries) mapping one or more virtual addresses (e.g., guest virtual addresses) to one or more other virtual address (e.g., guest virtual addresses, host virtual addresses), one or more physical addresses (e.g., system physical addresses, host physical address, guest physical address), or both. Further, address translation circuitry 244 is configured to perform one or more table walks through the set of page tables so as to translate one or more virtual addresses indicated in a memory access request to one or more other virtual addresses, one or more physical addresses, or both.

According to some implementations, AID 200 is configured to concurrently support two or more types of compute dies 128 (e.g., CCDs, ADs). To this end, AID 200 includes a respective set of circuitry to support each type of compute die 128 supported by AID 200. In some implementations, to support a first type of compute die 128 (e.g., CCD), scalable data fabric 126 includes a first set of circuitry that includes cache coherency circuitry 234, memory management circuitry, address translation circuitry 244, and I/O circuitry 246. For example, to support a first type of compute die 128, scalable data fabric 126 is configured to communicatively couple the processor cores of a first type of compute die 128 to cache coherency circuitry 234, memory management circuitry, address translation circuitry 244, and I/O circuitry 246. Cache coherency circuitry 234, for example, is configured to maintain coherency between the caches one or more compute dies 128 (e.g., CCDs), the caches one or more compute dies 128 and the caches one or more CPUs 102, or both. As an example, cache coherency circuitry 234 is configured to store and monitor one or more shadow tags in the caches (e.g., in the cache lines) of one or more compute dies 128, one or more CPUs 102, or both to maintain coherency between the caches of one or more compute dies 128, the caches one or more compute dies 128 and the caches one or more CPUs 102, or both. In some implementations, scalable data fabric 126 includes two instances of cache coherency circuitry 234 for each CCD supported by the AID 200. That is to say, scalable data fabric 126 includes two instances of cache coherency circuitry 234 for every CCD of a number of CCDs concurrently supported by the AID 200 (e.g., the number of CCDs that are able to be on AID 200 concurrently).

According to implementations, to support a second type of compute die 128 (e.g., AD) different from the first type of compute die 128, scalable data fabric 126 includes a second set of circuitry that includes graphics coherency circuitry 236, memory management circuitry 240, subnetwork 238, address translation circuitry 244, and I/O circuitry 246. For example, to support a second type of compute die 128, scalable data fabric 126 is configured to communicatively couple the processor cores of a second type of compute die 128 to graphics coherency circuitry 236 and subnetwork 238. Graphics coherency circuitry 236, for example, is configured to maintain coherency between the caches one or more compute dies 128 (e.g., ADs), the caches one or more compute dies 128 and the caches one or more CPUs 102, or both. As an example, graphics coherency circuitry 236 is configured to store and monitor one or more shadow tags in the caches (e.g., in the cache lines) of one or more compute dies 128, one or more CPUs 102, or both to maintain coherency between the caches of one or more compute dies 128, the caches one or more compute dies 128 and the caches one or more CPUs 102, or both. According to some implementations, scalable data fabric 126 includes 16 instances of graphics coherency circuitry 236 for each AD supported by the AID 200. That is to say, scalable data fabric 126 includes 16 instances of graphics coherency circuitry 236 for every AD of a number of ADs concurrently supported by the AID 200 (e.g., the number of ADs that are able to be on AID 200 concurrently).

Subnetwork 238, for example, includes circuitry configured to communicatively couple each processor core of an AD on AID 200 to one another; each processor core of an AD to memory management circuitry 240, address translation circuitry 244, I/O circuitry 246, or any combination thereof; or both. For example, in implementations, subnetwork 238 is configured for point-to-point routing so as to communicatively couple each processor core of an AD on AID 200 to one another; each processor core of an AD to memory management circuitry 240, address translation circuitry 244, I/O circuitry 246, or any combination thereof; or both. To this end, for example, subnetwork 238 includes one or more virtual channels, address maps, ports, or any combination thereof configured to assist in communicatively coupling each processor core of an AD on AID 200 to one another; each processor core of an AD to memory management circuitry 240, address translation circuitry 244, I/O circuitry 246, or any combination thereof; or both.

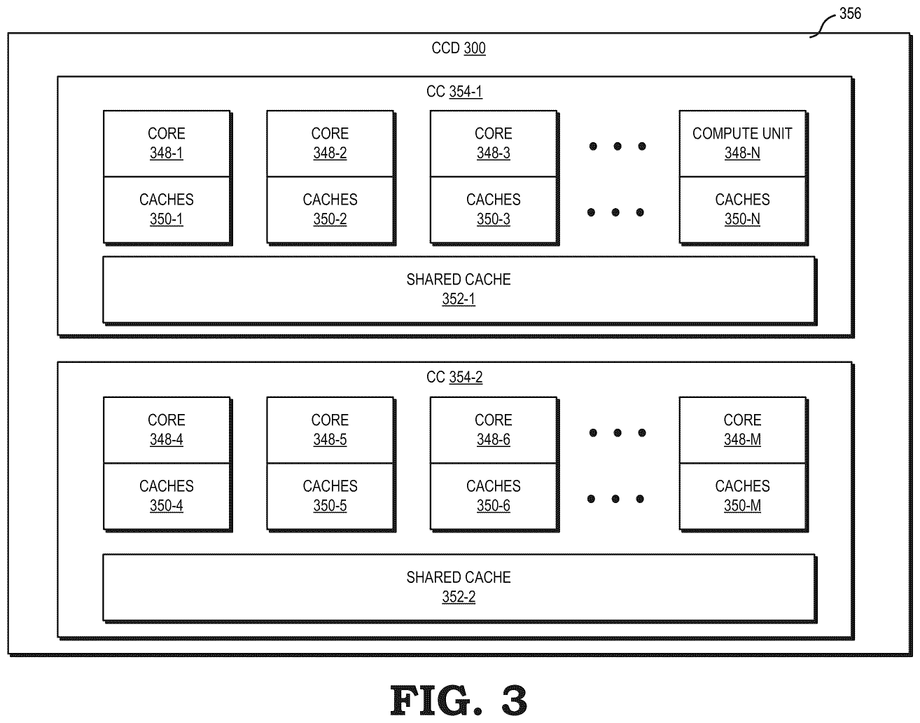

Referring now to FIG. 3, an example CCD 300 is presented. According to implementations, example CCD 300 is implemented in processing system 100 as one or more compute dies 128 in one or more AU 114. In implementations, CCD 300 includes a die 356 configured to support one or more core chiplets (CCs) 354. Though the example implementation presented in FIG. 3 shows die 356 supporting two CCs (354-1, 354-2), in other implementations, die 356 can support any non-zero integer number of CCs 354. Each CC 354, for example, includes a chiplet disposed on die 356 that includes one or more processor cores 348 each operating as one or more compute units. As an example, each CC 354 includes processor cores 348 each operating as one or more compute units that are configured to execute operations for one or more instructions, commands, and draw calls concurrently or in parallel for one or more applications 108. Though the example implementation presented in FIG. 3 shows a first CC 354-1 as including four processor cores (348-1, 348-2, 348-3, 348-N) representing an N integer number of processor cores and a second CC 354-2 as including four processor cores (348-4, 348-5, 348-6, 348-M) representing an M integer number of processor cores, in other implementations, a CC 354 can include any non-zero integer number of processor cores 348. Further, in implementations, one or more CCs 354 of a CCD 300 include the same number of processor cores 348, a different number of processor cores 348, or both. According to implementations, die 356 is configured to communicatively couple at least a portion of each CC 354 (e.g., one or more processor cores 348, one or more caches 350, 352) to at least a portion of another CC 354, a scalable data fabric 126 of an AID 118, or both.

In implementations, to help each processor core 348 execute one or more instructions, commands, and draw calls concurrently or in parallel for one or more applications 108, each CC 354 includes one or more caches 350 included in or otherwise connected to each processor core 348. As an example, each CC 354 includes a respective private cache 350 included in or otherwise connected to each processor core 348. According to implementations each cache 350 is configured to store data used in the execution of one or more instructions, commands, and draw calls by a corresponding processor core 348 (e.g., operands, constants, variables, register files), data resulting from the execution of one or more instructions, commands, and draw calls by a corresponding processor core 348 (e.g., results), or both. Though the example implementation in FIG. 3 shows each CC 354 including one cache (350-1, 350-2, 350-3, 350-4, 350-5, 350-6, 350-N, 350-M) for each processor core 348, in other implementations, each CC 354 can include any non-zero integer number of caches 350 each included in or otherwise connected to one or more processor cores 348. Additionally, according to implementations, each CC 354 includes one or more shared caches (352-1, 352-2) each communicatively coupled to two or more processor cores 348 of the CC 354. As an example, a CC 354 includes a shared cache 352 communicatively coupled to each processor core 348 of the CC 354. Because one or more shared caches 352 are communicatively coupled to two or more processor cores 348 of a CC 354, the shared caches 352 allow for data to be exchanged between the processor cores 348. That is to say, because two or more processor cores 348 are configured to write and read data to and from the same shared cache 352, the processor cores 348 are enabled to exchange data. Though the example implementation in FIG. 3 presents each CC 354 each including a single shared cache 352 communicatively coupled to two or more processor cores 348, in other implementations, each CC 354 can include any number of shared caches 352 each communicatively coupled to two or more processor cores 348. Further, in implementations, one or more CCs 354 of CCD 300 include the same number of shared caches 352, a different number of shared caches 352, or both.

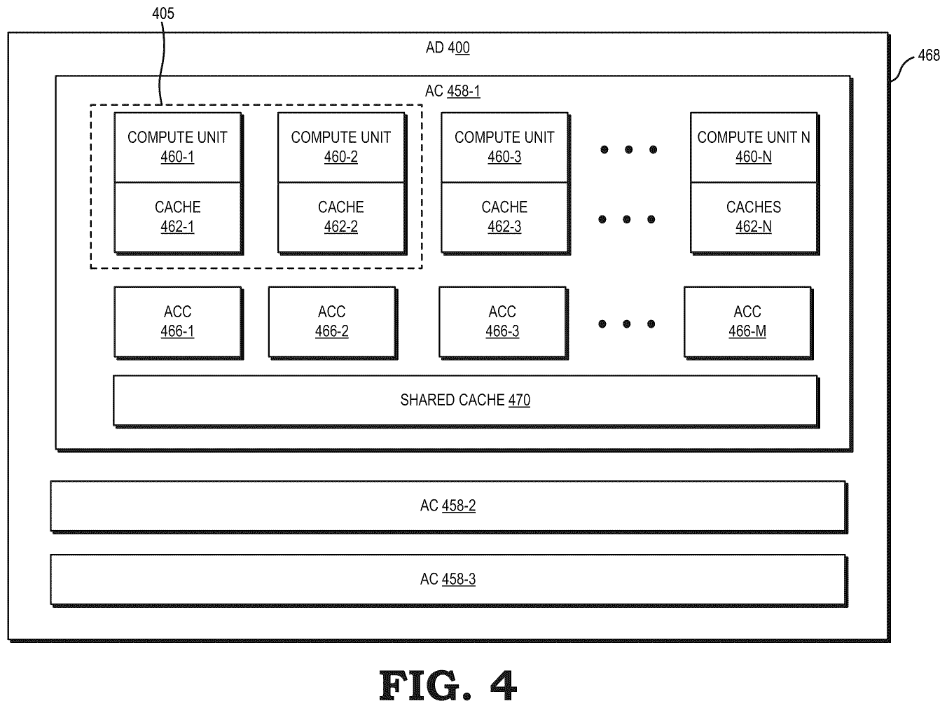

Referring now to FIG. 4, an example AD 400 is presented, in accordance with some implementations. According to implementations, example AD 400 is implemented in processing system 100 as one or more compute dies 128 in one or more AUs 114. In implementations, AD 400 includes a die 468 configured to concurrently support one or more accelerated complexes (ACs) 458. Though the example implementation presented in FIG. 4 shows AD 400 as concurrently supporting three ACs (458-1, 458-2, 458-3), in other implementations, AD 400 can include any number of ACs 458. Each AC 458, for example, includes a chiplet disposed on die 468 having one or more compute units 460 (e.g., physical compute units) configured to execute operations for one or more instructions, commands, and draw calls concurrently or in parallel for one or more applications 108. Though the example implementation presented in FIG. 4 shows an AC 458 as including four compute units (460-1, 460-2, 460-3, 460-N) representing an N integer number of compute units, in other implementations, an AC 458 can include any non-zero integer number of compute units 460. In implementations, one or more ACs 458 of an AD 400 include the same number of compute units 460, a different number of compute units 460, or both. According to implementations, die 468 is configured to communicatively couple at least a portion of each AC 458 (e.g., one or more compute units 460, one or more caches 462, 470) to at least a portion of another AC 458, a scalable data fabric 126 of an AID 118, or both.

To assist each compute unit 460 in executing operations for one or more instructions, commands, and draw calls concurrently or in parallel for one or more applications 108, each AC 458 includes one or more caches 462 included in or otherwise connected to each compute unit 460. As an example, each AC 458 includes a respective private cache 462 included in or otherwise connected to each compute unit 460. According to implementations each cache 462 is configured to store data used in the execution of operations of one or more instructions, commands, and draw calls by a corresponding compute unit 460 (e.g., operands, constants, variables, register files), data resulting from the execution of one or more instructions, commands, and draw calls by a corresponding compute unit 460 (e.g., results), or both. Though the example implementation in FIG. 4 shows each AC 458 including one cache (462-1, 462-2, 462-3, 462-N) for each compute unit 460, in other implementations, each AC 458 can include any number of caches 462 each included in or otherwise connected to one or more compute units 460. Further, in implementations, each AC 458 includes one or more shared caches 470 each communicatively coupled to two or more compute units 460 of the AC 458. As an example, an AC 458 includes a shared cache 470 communicatively coupled to each compute unit 460 of the AC 458. Because one or more shared caches 470 are communicatively coupled to two or more compute units 460 of an AC 458, the shared caches 470 allow for data to be exchanged between the compute units 460. Though the example implementation in FIG. 4 presents an AC 458 as including a single shared cache 470 communicatively coupled to two or more compute units 460, in other implementations, each AC 458 can include any non-zero integer number of shared caches 470 each communicatively coupled to two or more compute units 460. Further, in implementations, one or more ACs 458 of AD 400 include the same number of shared caches 470, a different number of shared caches 470, or both.

According to implementations, each AC 458 includes one or more accelerators configured to help perform one or more operations for one or more applications 108. Such accelerators, for example, include hardware-based accelerators (e.g., hardware-based encoders, hardware-based decoders), FPGA-based accelerators, asynchronous computing circuitry, or any combination thereof, to name a few. As an example, in some implementations, each AC 458 is configured to execute one or more instructions, commands, and draw calls for one or more applications 108 asynchronously. That is to say, each AC 458 is configured to execute one or more instructions, commands, and draw calls of a pipeline prior to completing the execution of one or more instructions, commands, or draw calls that occur previously in the pipeline. To this end, each AC 458 includes one or more instances of asynchronous computing circuitry (ACC) 466. Each ACC 466, for example, is communicatively coupled to a number of compute units 460 and is configured to assign instructions, commands, and draw calls of a pipeline to each coupled compute unit 460 for execution. As an example, an ACC 466 is configured to assign operations for an instruction, command, or draw call of a pipeline to a compute unit 460 for execution before the execution of one or more instructions, commands, or draw calls occurring previously in the pipeline has completed. In implementations, each ACC 466 is configured to assign operations for one or more tasks (e.g., instructions, commands, draw calls) to a respective subset of compute units 460 of the AC 458. As an example, a first ACC 466-1 is configured to assign operations to a first subset of compute units 460 and a second ACC 466-2 is configured to assign operations to a second subset of compute units 460 that is different and distinct from the first subset of compute units 460. Though the example implementation presented in FIG. 4 shows an AC 458 as including four ACCs (466-1, 466-3, 466-3, 466-M) representing an M integer number of ACCs 466, in other implementations each AC 458 can include any non-zero integer number of ACCs 466. For example, in implementations, one or more ACs 458 of AD 400 include a same number of ACCs 466, a different number of ACCs 466, or both.

In some implementations, each AC 458 includes one or more shader engines 405 that each have two or more compute units 460, two or more caches 462, or both. That is to say, an AC 458 includes compute units 460, caches 462, or both each grouped into distinctive subsets that each form a respective shader engine 405. Each shader engine 405, for example, is configured to perform one or more operations such as operations to determine light levels, darkness levels, color levels, or any combination thereof for a scene to be rendered. According to some implementations, each shader engine 405 includes a group of sixteen distinct compute units 460 while in other implementations each shader engine 405 includes a group have any non-zero integer number of distinct compute units 460. In implementations, each ACC 466 is configured to support a corresponding shader engine 405. That is to say, each ACC 466 is configured to support a distinct group of compute units 460 forming a shader engine 405.

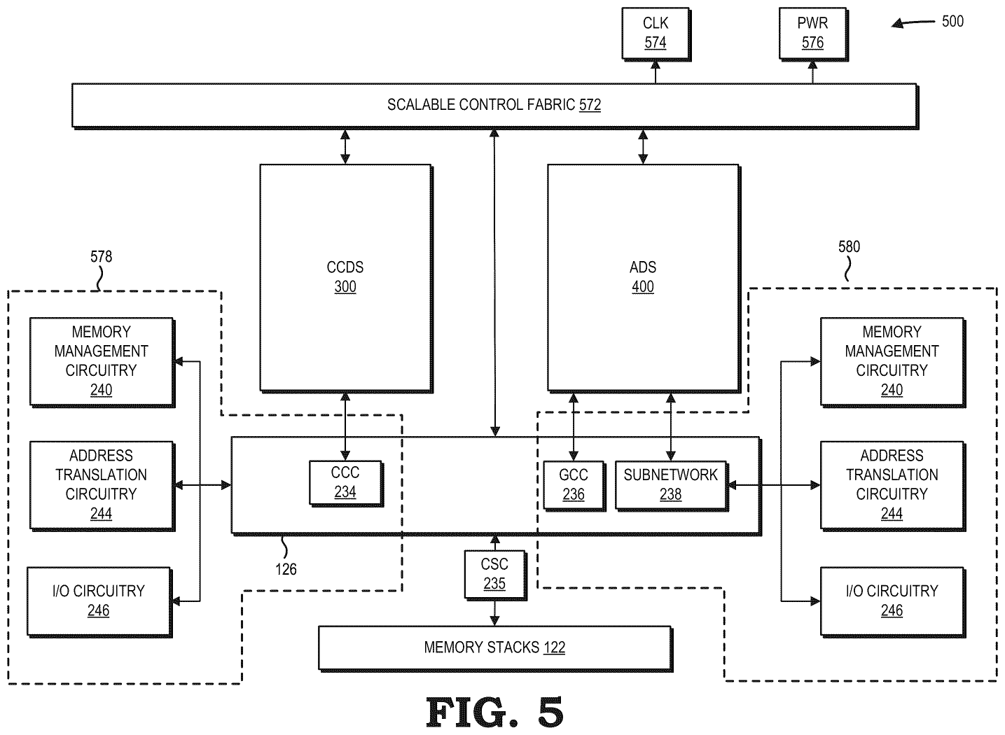

Referring now to FIG. 5, an example architecture 500 for an AID is presented. According to implementations, example architecture 500 is implemented in one or more AIDs 118 of processing system 100, AID 200, or both. In implementations, example architecture 500 includes a scalable data fabric 126 configured to concurrently support one or more CCDs 300, one or more ADs 400, or both. As an example, in some implementations, scalable data fabric 126 is configured to concurrently support one or more CCDs 300. In other implementations, scalable data fabric 126 is configured to concurrently support one or more ADs 400. Further, in some implementations, scalable data fabric 126 is configured to concurrently support one or more CCDs 300 and one or more ADs 400. To this end, within example architecture 500, scalable data fabric 126 includes a first set of circuitry 578 configured to support one or more CCDs 300. Such a first set of circuitry 578, for example, includes one or more instances of cache coherency circuitry 234, memory management circuitry 240, address translation circuitry 244, I/O circuitry 246, or any combination thereof. As an example, within architecture 500, scalable data fabric 126 is configured to first couple each CCD 300 to one or more respective instances of cache coherency circuitry 234. For example, within some implementations, scalable data fabric 126 includes two respective instances of cache coherency circuitry 234 for each CCD 300 concurrently supported by scalable data fabric 126. Scalable data fabric 126, for example, is configured to communicatively couple each instance of cache coherency circuitry 234 to a corresponding CC 354 of a supported CCD 300 so as to maintain coherency between the caches of the corresponding CC 354 and the caches of one or more other CCs 354 (e.g., other CCs 354 of the supported CCDs 300), the caches of one or more AUs 114, the caches of one or more CPUs 102, or any combination thereof. As an example, in addition to scalable data fabric 126 being configured to communicatively couple each CC 354 of a supported CCD 300 to a corresponding instance of cache coherency circuitry 234, scalable data fabric 126 is configured to communicatively each CC 354 of a supported CCD to one or more memory stacks 122 via coherency station circuitry 235. Coherency station circuitry 235, for example, is configured to maintain coherent memory for a given address space (e.g., address space of a memory stack 122) and manage data and ownership responses required by a given transaction. To this end, in some implementations, coherency station circuitry 235 is configured to perform snooping-based coherency techniques, directory-based coherency techniques, or both. Further, scalable data fabric 126 is configured to communicatively couple each CCD 300 to memory management circuitry 240, address translation circuitry 244, I/O circuitry 246, or any combination thereof.

Further, within example architecture 500, scalable data fabric 126 includes a second set of circuitry 580 configured to concurrently support one or more ADs 400. The second set of circuitry 580, as an example, includes one or more instances of graphics coherency circuitry 236, subnetwork 238, memory management circuitry 240, address translation circuitry 244, I/O circuitry 246, or any combination thereof. As an example, within architecture 500, scalable data fabric 126 is configured to communicatively couple each AD 400 to one or more respective instances of graphics coherency circuitry 236. As an example, in implementations, scalable data fabric 126 includes sixteen respective instances of graphics coherency circuitry 236 for each AD 400 concurrently supported by scalable data fabric 126. In some implementations, scalable data fabric 126 includes a respective instance of graphics coherency circuitry 236 for each shader engine 405 (e.g., each distinct groups of compute units 460) formed on the AD 400. As an example, to support an AD 400 including a first AC 458 having eight shader engines 405 and a second AC 458 also having eight shader engines 405, scalable data fabric 126 includes sixteen respective instances of graphics coherency circuitry 236. Scalable data fabric 126, for example, is configured to communicatively couple each instance of graphics coherency circuitry 236 to one or more compute units 460 of an AC 458. For example, in some implementations, scalable data fabric 126 is configured to communicatively couple each instance of graphics coherency circuitry 236 to a corresponding shader engine 405 of an AC 458 of a supported AD 400. In implementations, scalable data fabric 126 is configured to communicatively couple each instance of graphics coherency circuitry 236 to one or more compute units 460 of an AC 458 so as to maintain coherency between the caches of the compute units 460 and the caches of one or more other ACs 458 (e.g., other ACs 458 of the supported ADs 400), the caches of one or more AUs 114, the caches of one or more CPUs 102, or any combination thereof. For example, in addition to scalable data fabric 126 being configured to communicatively couple the compute units 460 of an AC 458 to corresponding instances of graphics coherency circuitry 236, scalable data fabric 126 is configured to communicatively the compute units 460 of the AC 458 to one or more memory stacks 122 via coherency station circuitry 235.

Additionally, in implementations, the second set of circuitry 580 includes subnetwork 238 configured to communicatively couple the compute units 460 of each supported AD 400 to one another, to memory management circuitry 240, to address translation circuitry 244, to I/O circuitry 246, or any combination thereof. For example, subnetwork 238 includes one or more virtual channels, address maps, ports, or any combination thereof configured to assist in communicatively coupling each compute unit 460 of the concurrently supported ADs 400 to one another, to memory management circuitry 240, to address translation circuitry 244, to I/O circuitry 246, or any combination thereof. In some implementations, the first set of circuitry 578 is distinct from the second set of circuitry 580 while in other implementations, the first set of circuitry 578 is included in the second set of circuitry 580.

In some implementations, example architecture 500 also includes scalable control fabric 572 included in or otherwise communicatively coupled to scalable data fabric 126. Scalable control fabric 572, for example, includes circuitry configured to communicatively couple the concurrently supported CCDs 300 and ADs 400 to one or more control elements (e.g., clock generators, power system managers, fuses, system managers). As an example, in implementations, scalable control fabric 572 is configured to communicatively provide control signals from one or more processor cores 348 of one or more CCDs 300, one or more compute units 460 (e.g., shader engines 405) of one or more ADs 400, or both to one or more clock generators (e.g., CLK 574), power system managers (e.g., PWR 576), fuses, system managers, or the like. Such control signals, for example, include data indicating one or more frequencies for a clock signal to be generated (e.g., provided to CLK 574), a voltage to be generated (e.g., provided to PWR 576), a current to be generated (e.g., provided to PWR 576), a power state for one or more components of processing system 100 (e.g., provided to a system manager), or any combination thereof, to name a few. A system manager, for example, includes circuitry configured to place at least a portion of one or more components of processing system 100 in one or more operating states, low-power states, or both.

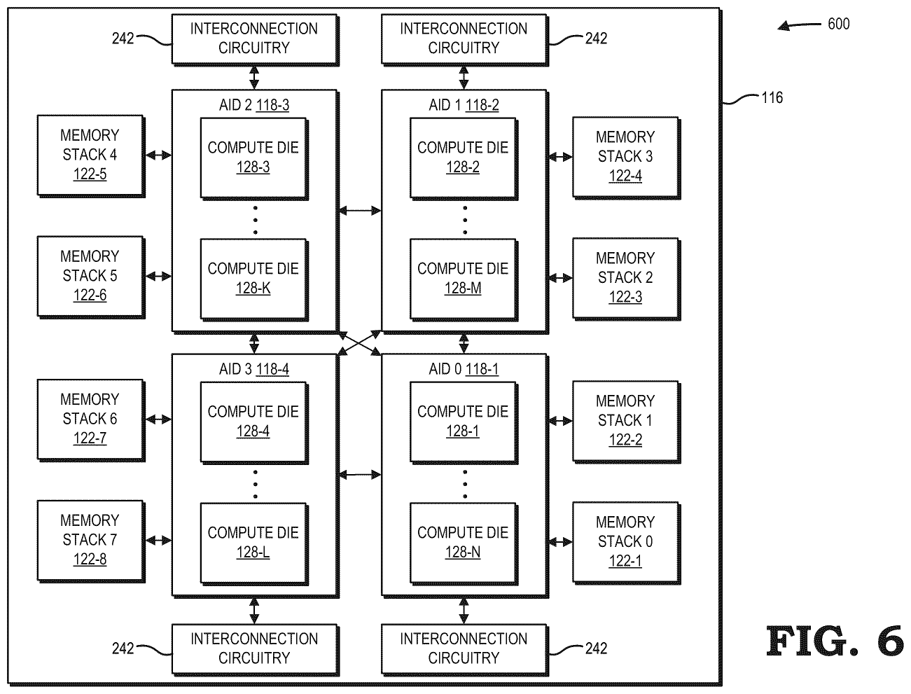

Referring now to FIG. 6, an example AU 600 is presented, in accordance with some implementations. In implementations, AU 600 is implemented in processing system 100 as one or more AUs 114. According to implementations, AU 600 includes connection circuitry 116 upon which eight memory stacks (122-1, 122-2, 122-3, 122-4, 122-5, 122-6, 122-7, 122-8) are disposed. Though the example implementation in FIG. 6 presents AU 600 as including eight memory stacks (122-1, 122-2, 122-3, 122-4, 122-5, 122-6, 122-7, 122-8), in other implementations, AU 600 can include any non-zero integer number of memory stacks 122. Additionally, in implementations, AU 600 includes four AIDs (AID 0 118-1, AID 1 118-2, AID 2 118-3, AID 3 118-4) disposed upon connection circuitry 116. According to implementations, the AIDs 118 are disposed on connection circuitry 116 such that each AID 118 is communicatively coupled to each other AID 118. Though the example implementation in FIG. 6 presents AU 600 as including four AIDs (118-1, 118-2, 118-3, 118-4), in other implementations, AU 600 can include any number of AIDs 118.

Further, in some implementations, each AID 118 is disposed on connection circuitry such that each AID 118 is communicatively coupled to one or more respective memory stacks 122. For example, in implementation presented in FIG. 6, AID 0 118-1 is communicatively coupled to memory stack 0 122-1 and memory stack 1 122-2; AID 1 118-2 is communicatively coupled to memory stack 2 122-3 and memory stack 3 122-4; AID 2 118-3 is communicatively coupled to memory stack 4 122-5 and memory stack 5 122-6; and AID 3 118-4 is communicatively coupled to memory stack 6 122-7 and memory stack 7 122-8. Though the example implementation presented in FIG. 6 shows each AID 118 as communicatively coupled to two corresponding memory stacks 122, in other implementations, each AID 118 may be communicatively coupled to any number of memory stacks 122. According to implementations, each AID 118 is configured to concurrently support two or more respective compute dies 128. For example, referring to the implementation presented in FIG. 6, AID 0 118-1 is configured to support compute die 128-1 and 128-N; AID 1 118-2 is configured to support compute die 128-2 and 128-M; AID 2 118-3 is configured to support compute die 128-3 and 128-K; and AID 3 118-4 is configured to support compute die 128-4 and 128-L. Though the example implementation presented in FIG. 6 shows each AID (118-1, 118-2, 118-3, 118-4) support two compute dies 128 each representing an N, M, K, and L integer number of compute dies 128, respectively, in other implementations, each AID 118 can support any non-zero integer number of compute dies 128. As an example, in implementations, one or more AIDs 118 of AU 600 are configured to support the same number of compute dies 128, a different number of compute dies 128, or both. In some implementations one or AIDs 118 are configured to concurrently support two or more types (e.g., CCDs 300, ADs 400) of compute dies 128.

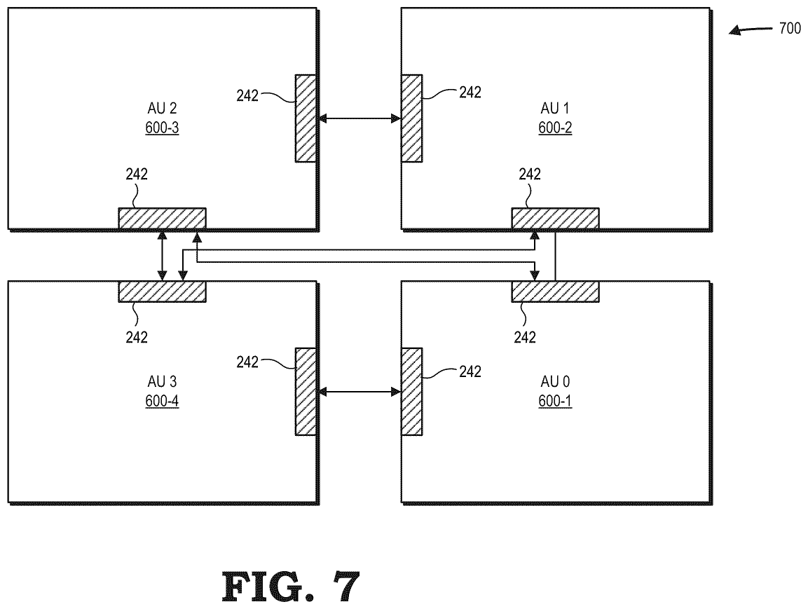

To communicatively couple AU 600 to one or more other AUs 114, one or more components of processing system 100 (e.g., CPU 102, memory 106), or both, each AID 118 includes or is otherwise connected to a respective instance of interconnection circuitry 242. Interconnection circuitry 242 includes, for example, ports (e.g., PCIe ports, USB ports), layers (e.g., PCIe layers, CXL layers, USB layers), traces, wires, and the like configured to communicate couple the compute dies 128 of an AID 118 to one or more other AIDs 118 of one or more other AUs 114, one or more components of processing system 100, or both. As an example, referring now to FIG. 7, an example architecture 700 for two or more interconnected AUs 600 is presented, in accordance with some implementations. In implementations, example architecture 700 includes four AUs (600-1, 600-2, 600-3, 600-4) each including respective instances of interconnection circuitry 242. Using respective instances of interconnection circuitry 242, each AU 600 is configured to be communicatively coupled to each other AU 600 within example architecture 700. For example, using respective instances of interconnection circuitry 242, a first AU 0 600-1 is communicatively coupled to the interconnection circuitry 242 of AU 1 600-2, AU 2 600-3, and AU 3 242. Due to each AU 600 being communicatively coupled by the instances of interconnection circuitry 242, each AU 600 is configured to send and receive data to and from each other AU 600. For example, each AU 600 is configured to send and receive data to and from each compute die 128 supported by the AIDs 118 of each AU 600.

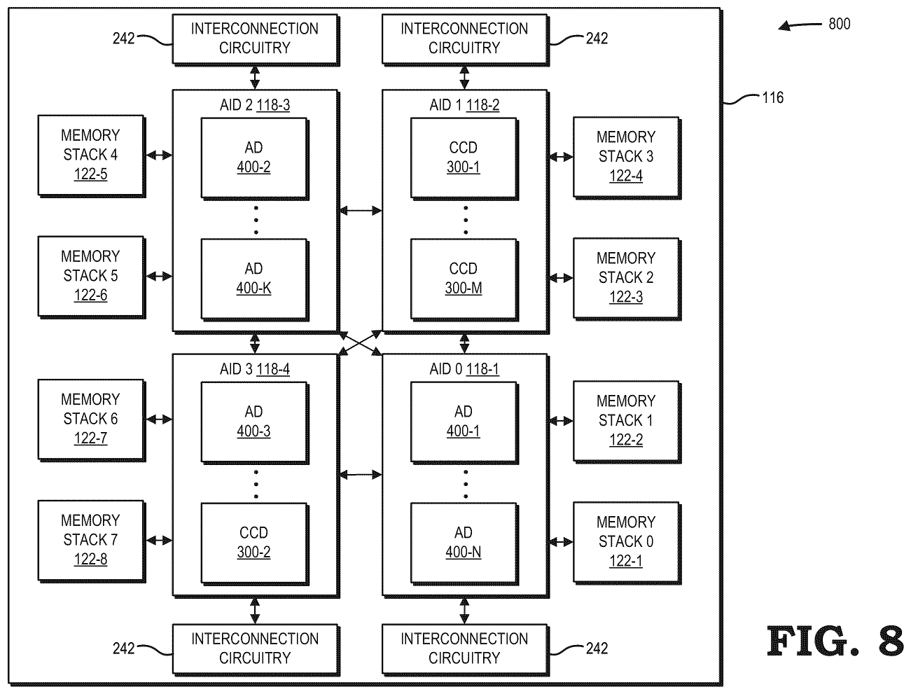

Referring now to FIG. 8, an example AU 800, similar to or the same as example AU 600 is presented, in accordance with some implementations. In implementations, AU 800 is implemented in processing system 100 as one or more AUs 114. In implementations, AU 800 is configured to concurrently support two types of compute dies 128. As an example, AU 800 is configured to concurrently support one or more CCDs 300 and one or more ADs 400. To this end, AU 800 includes a number of AIDs 118 each configured to support one or more CCDs 300, ADs 400, or both. Referring to the example implementation presented in FIG. 8, a first AU 0 118-1 of AU 800 is configured to support two ADs 400-1, 400-N representing an N number of ADs 400. Further, AU 800 includes a second AID 1 118-2 configured to support two CCDs 300-1, 300-M representing an M number of CCDs 300. A third AID 2 118-3 of AU 800 is configured to support two ADs 400-2, 400-k representing a K number of ADs 400. Additionally, AU 800 includes a fourth AID 3 118-4 configured to support at least one AD 400-3 and at least one CCD 300-2. Though the example implementation presented in FIG. 8 presents each AID 118 as concurrently supporting two compute dies 128 representing, for example, an N, M, or K number of cores, respectively, in other implementations, each AID 118 of AU 800 can concurrently support any number of compute dies 128 each of one or more types (CCDs 300, ADs 400). That is to say, each AID 118 of AU 800 can concurrently support any number of CCDs 300 and any number of ADs 400.

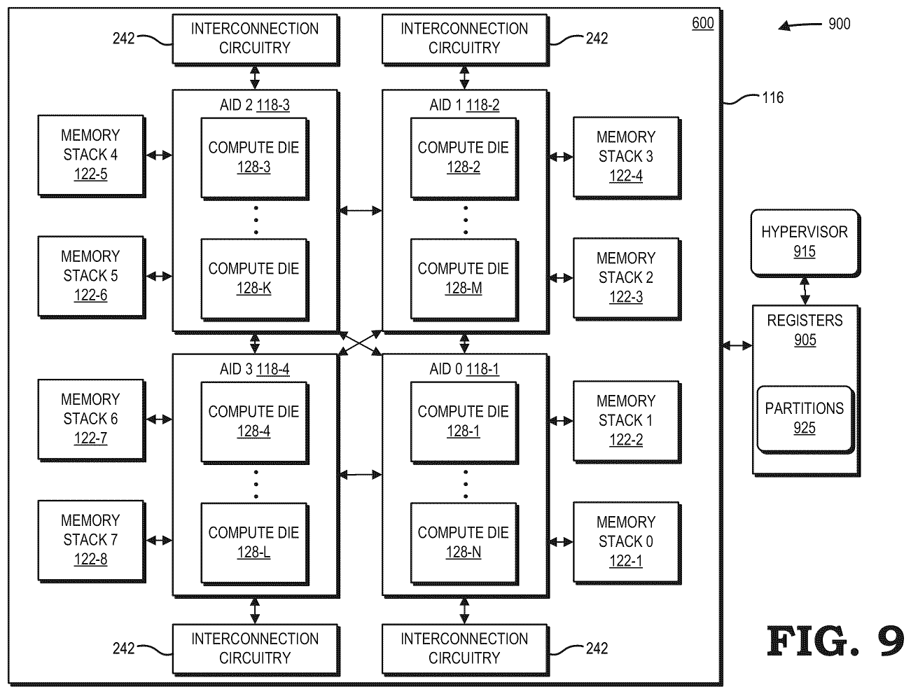

Referring now to FIG. 9, an example partitioning operation 900 for one or more AUs is presented. In implementations, the example partition operation 900 is implemented for one or more AUs 600 by, for example, CPU 102. According to implementations, AU 600 includes or is otherwise connected to a set of registers 905 (e.g., base access registers) that control the partitions 925 of each memory stack 122, each compute die 128, or both. That is to say, the set of registers 905 includes values that indicate two or more partitions 925 that each include two or more memory stacks 122, two or more compute dies 128, or both. Within example partitioning operation 900, hypervisor 915 is configured to create a partition 925 in response to one or more virtual machines being launched by processing system 100 and assign the created partition to the virtual machine. For example, based on a virtual machine being launched by processing system 100, hypervisor 915 edits the data in one or more registers of the set of registers 905 so as to create a partition 925 including one or more memory stacks 122, one or more compute dies 128, or both. After creating the partition 925, hypervisor 915 is configured to assign the partition 925 to the launched virtual machine. After a partition 925 is assigned to a virtual machine, the virtual machine has access to the memory stacks 122 and compute dies 128 within the partition 925 such that the virtual machine is enabled to use the memory stacks 122 and compute dies 128 within the partition 925 to perform instructions, commands, and tasks for one or more applications 108. In some implementations, each partition 925 of AU 600 is realized using bare metal partitioning.

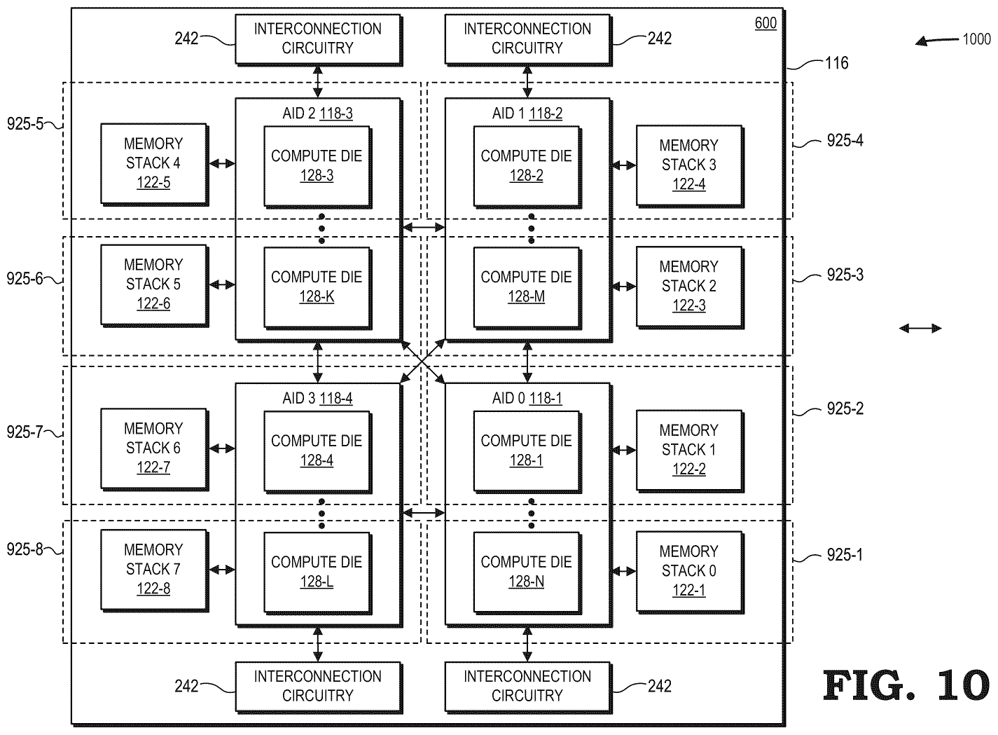

FIGS. 10 to 12 each present respective partition schemes 1000, 1100, 1200 for an example AU 600. For example, referring now to FIG. 10, an example partition scheme 1000 for an example AU 600 is presented, in accordance with implementations. In implementations, example partition scheme 1000 is a result of performing example partition operation 900 by, for example, CPU 102. In implementations, partition scheme 1000 includes hypervisor 915 editing the set of registers 905 such that eight partitions 925-1, 925-2, 925-3, 925-4, 925-5, 925-6, 925-7, and 925-8 are created. Each partition 925, for example, includes at least one compute die 128 and at least one memory stack 122. Referring to the example implementation presented in FIG. 10, a first partition 925-1 includes compute die 128-N and memory stack 0 122-1, a second partition 925-2 includes compute die 128-1 and memory stack 1 122-2, a third partition 925-3 includes compute die 128-M and memory stack 2 122-3, a fourth partition 925-4 includes compute die 128-2 and memory stack 3 122-4, a fifth partition 925-5 includes compute die 128-3 and memory stack 4 122-5, a sixth partition 925-6 includes compute die 128-K and memory stack 5 122-6, a seventh partition 925-7 includes compute die 128-4 and memory stack 6 122-7, and an eight partition 925-8 includes compute die 128-L and memory stack 7 122-8. According to implementations, hypervisor 915 is configured to assign each partition 925-1, 925-2, 925-3, 925-4, 925-5, 925-6, 925-7, and 925-8 to a corresponding application 108 being executed by processing system 100.

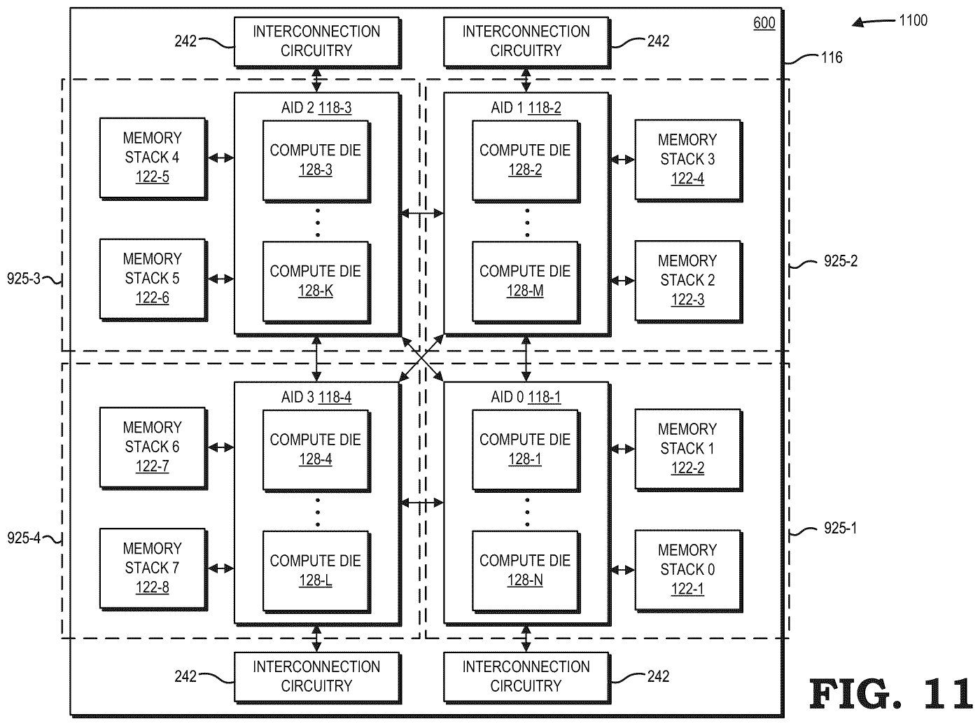

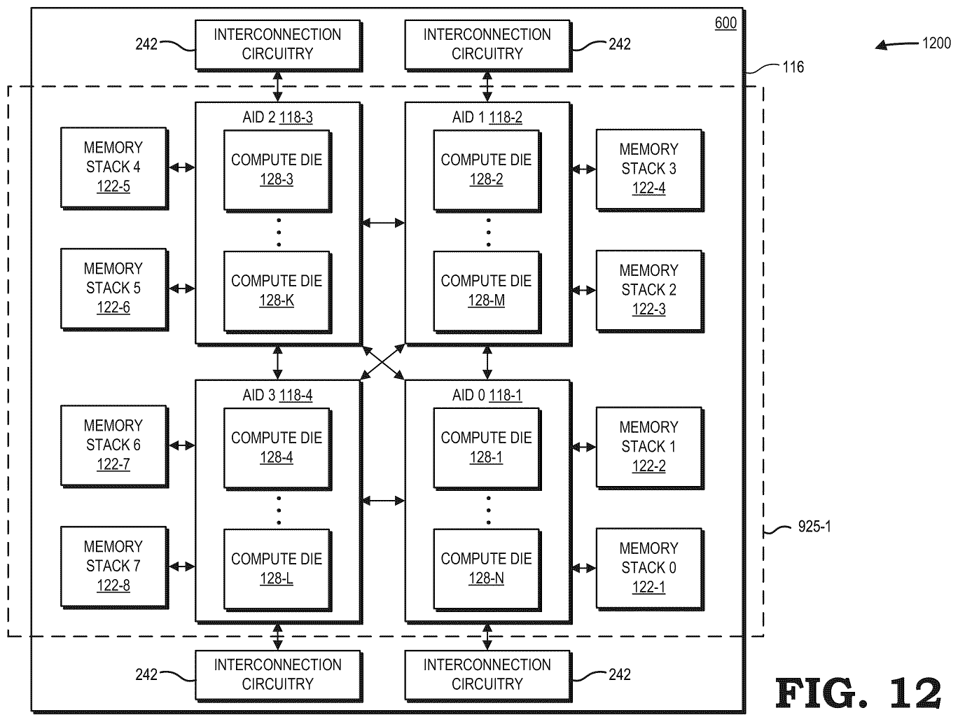

Referring now to FIG. 11, an example partition scheme 1100 for an example AU 600 is presented, in accordance with implementations. In implementations, example partition scheme 1100 is a result of performing example partition operation 900 by, for example, CPU 102. In implementations, partition scheme 1100 includes hypervisor 915 editing the set of registers 905 such that four partitions 925-1, 925-2, 925-3, 925-4 are created. Each partition 925, for example, includes at least two compute dies 128 and at least two memory stacks 122. Referring to the example implementation presented in FIG. 11, a first partition 925-1 includes compute dies 128-1, 128-N and memory stacks 122-1, 122-2; a second partition 925-2 includes compute dies 128-2, 128-M and memory stacks 122-3, 122-4; a third partition 925-3 includes compute dies 128-3, 128-K and memory stacks 122-5, 122-5; and a fourth partition 925-4 includes compute dies 128-4, 128-L and memory stacks 122-7, 122-8. According to implementations, hypervisor 915 is configured to assign each partition 925-1, 925-2, 925-3, and 925-4 to a corresponding application 108 being executed by processing system 100. Referring now to FIG. 12, an example partition scheme 1200 for an example AU 600 is presented, in accordance with implementations. In implementations, example partition scheme 1200 is a result of performing example partition operation 900 by, for example, CPU 102. In implementations, partition scheme 1200 includes hypervisor 915 editing the set of registers 905 such that one partition 925-1 is created. The partition 925-1, for example, includes each compute die 128 and each memory stack 122 included in AU 600. According to implementations, hypervisor 915 is configured to the partition 925-1 to a corresponding application 108 being executed by processing system 100.

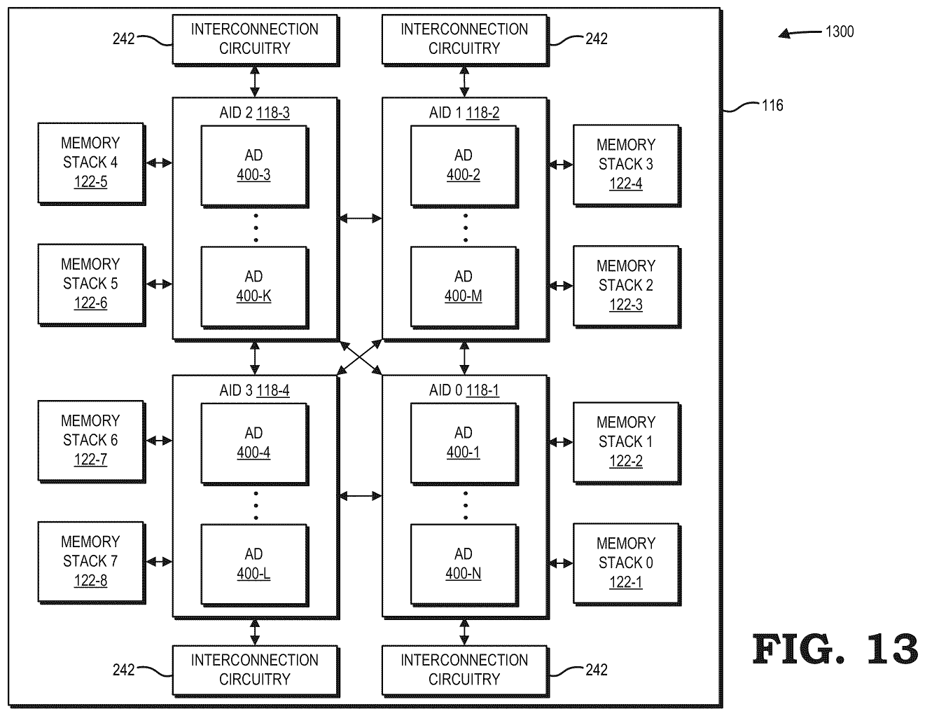

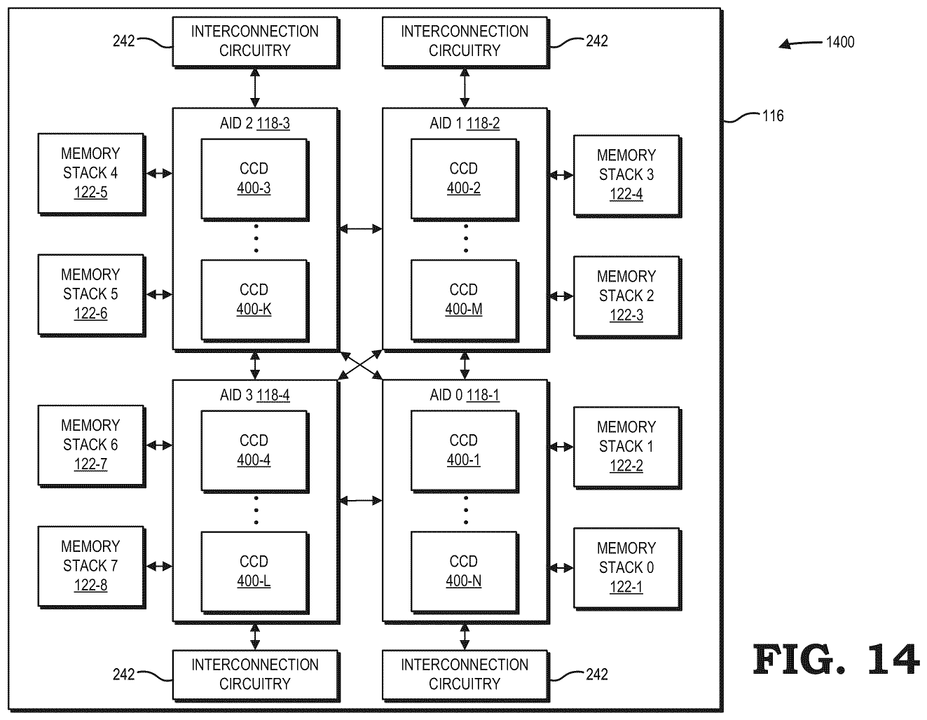

FIGS. 13 to 17 each present example AUs with respective architectures. As an example, referring now to FIG. 13, an example AU 1300 is presented. In implementations, example AU 1300 is implemented as one or more AUs 114 in processing system 100, as example AU 600, or both. According to implementations, example AU 1300 includes one or more AIDs 118 each including one or more ADs 400. For example, referring to the implementation presented in FIG. 13, example AU 1300 includes a first AID 0 118-1 including two ADs 400-1, 400-N representing an N number of ADs; a second AID 1 118-2 including two ADs 400-2, 400-M representing an M number of ADs; a third AID 2 118-3 including two ADs 400-2, 400-K representing a K number of ADs; and a fourth AID 3 118-4 including two ADs 400-4, 400 L representing an L number of ADs. Though the example implementation in FIG. 13 shows four AIDs 118 each including two ADs 400 representing an N, M, K, and L integer number of ADs, respectively, in other implementations, example AU 1300 can include any non-zero integer number AIDs 118 each having any respective non-zero integer number of ADs 400. In implementations, example AU 1300 is configured to perform one or more operations for one or more graphics applications 108, for example, performing operations to render one or more graphics objects. Referring now to FIG. 14, an example AU 1400 is presented. In implementations, example AU 1400 is implemented as one or more CPUs 102 in processing system 100. According to implementations, example AU 1400 includes one or more AIDs 118 each including one or more CCDs 300. For example, referring to the implementation presented in FIG. 14, example AU 1400 includes a first AID 0 118-1 including two CCDs 300-1, 300-N representing an N number of CCDs; a second AID 1 118-2 including two CCDs 300-2, 300-M representing an M number of CCDs; a third AID 2 118-3 including two CCDs 300-2, 300-K representing a K number of CCDs; and a fourth AID 3 118-4 including two CCDs 300-4, 300 L representing an L number of CCDs. Though the example implementation in FIG. 14 shows four AIDs 118 each including two CCDs 300 representing an N, M, K, and L integer number of CCDs, respectively, in other implementations, example AU 1400 can include any non-zero integer number AIDs 118 each having any respective non-zero integer number of CCDs 300. In implementations, example AU 1400 is configured to perform one or more operations for one or more compute applications 108, for example, performing operations for one or more machine-learning applications.

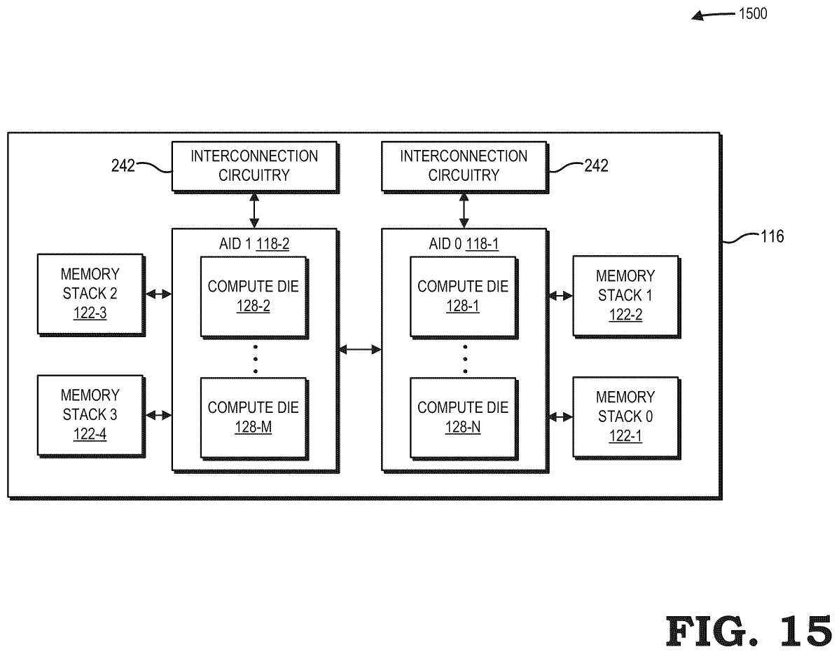

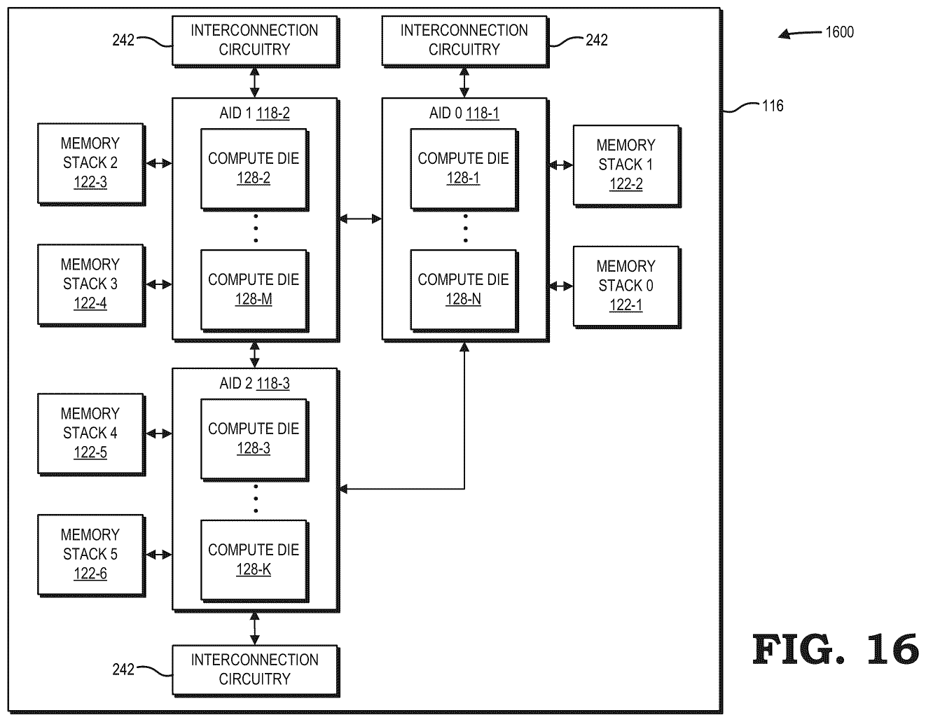

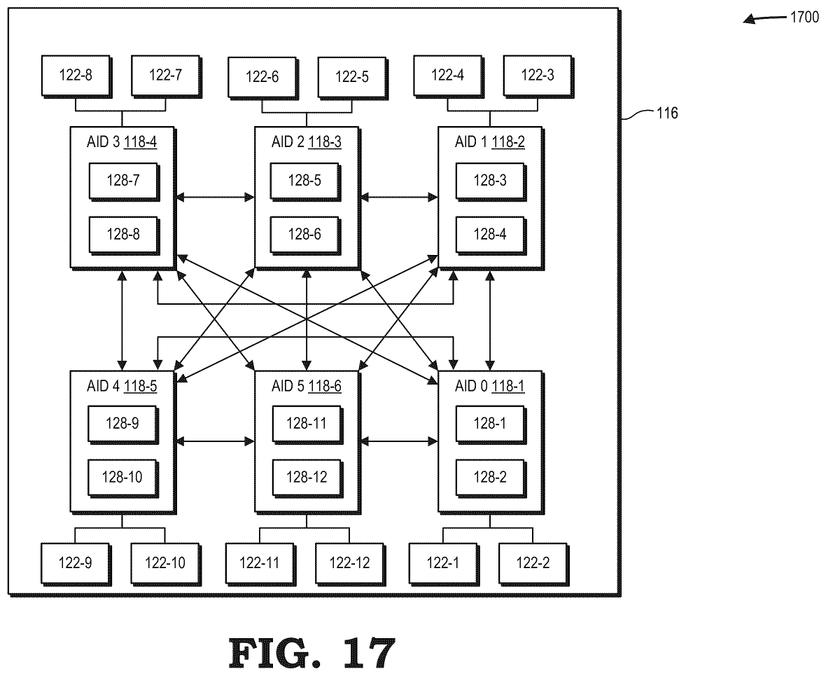

Referring now to FIG. 15, an example AU 1500 is presented. In implementations, example AU 1500 is implemented as one or more AUs 114, example AU 600, or both and includes two AIDs 118-1, 118-2 each including one or more compute dies 128 and each communicatively coupled to each other and two respective memory stacks 122. Though the example embodiment presented in FIG. 15 shows example AU 1500 as including AIDs 118 each connected to two memory stacks (122-1, 122-2, 122-3, 122-4), in other implementations, each AID 118 may be communicatively coupled to any number of memory stacks 122. Referring now to FIG. 16, an example AU 1600 is presented. In implementations, AU 1600 is implemented as one or more AUs 114, example AU 600, or both and includes three AIDs 118-1, 118-2, 118-3 each including one or more compute dies 128 and each communicatively coupled to each other and two respective memory stacks 122. Though the example embodiment presented in FIG. 16 shows example AU 1600 as including AIDs 118 each connected to two memory stacks (122-1, 122-2, 122-3, 122-4, 122-5, 122-6), in other implementations, each AID 118 may be communicatively coupled to any non-zero number of memory stacks 122. Referring now to FIG. 17, an example AU 1700 is presented. In implementations, example AU 1700 is implemented as one or more AUs 114, example AU 600, or both and includes six AIDs 118-1, 118-2, 118-3, 118-4, 118-5, 118-6 each including one or more compute dies 128 and each communicatively coupled to each other and two respective memory stacks 122. Though the example embodiment presented in FIG. 17 shows AU 1700 as including AIDs 118 each connected to two memory stacks (122-1, 122-2, 122-3, 122-4, 122-5, 122-6, 122-7, 122-8, 122-9, 122-10, 122-11, 122-12), in other implementations, each AID 118 may be communicatively coupled to any non-zero integer number of memory stacks 122.

In some implementations, the apparatus and techniques described above are implemented in a system including one or more integrated circuit (IC) devices (also referred to as integrated circuit packages or microchips), such as the AU described above with reference to FIGS. 1-17. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)—based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is set forth in the claims below.

What is claimed is:

1. An accelerator unit (AU), comprising:
a connection circuitry;
one or more memory stacks disposed on the connection circuitry; and
one or more interposer dies disposed on the connection circuitry such that each interposer die of the one or more interposer dies is communicatively coupled to a corresponding memory stack of the one or more memory stacks via the connection circuitry, wherein each interposer die of the one or more interposer dies is configured to concurrently support two or more compute dies.

2. The AU of claim 1, wherein each compute die includes a chiplet having one or more compute units.

3. The AU of claim 1, wherein an interposer die of the one or more interposer dies is configured to concurrently support a compute die having a first type and a compute die having a second type, wherein the first type is different from the second type.

4. The AU of claim 3, wherein the first type comprises a core complex die (CCD) and the second type comprises an accelerated core die (AD).

5. The AU of claim 3, wherein the interposer die of the one or more interposer dies includes a first set of circuitry to support the compute die having the first type and a second set of circuitry to support the compute die having the second type, wherein the first set of circuitry is different from the second set of circuitry.

6. The AU of claim 5, wherein the first set of circuitry includes cache coherency circuitry and the second set of circuitry includes graphics coherency circuitry.

7. The AU of claim 6, wherein the second set of circuitry includes a subnetwork configured to communicatively couple one or more ADs to a memory management circuitry.

8. The AU of claim 1, wherein the one or more interposer dies are disposed on the connection circuitry such that each interposer die of the one or more interposer dies is communicatively coupled to one or more other interposer dies.

9. A processing system, comprising:
a memory; and
an acceleration unit (AU), comprising:
a connection circuitry;
one or more memory stacks disposed on the connection circuitry; and
one or more interposer dies disposed on the connection circuitry such that each interposer die of the one or more interposer dies is communicatively coupled to a corresponding memory stack of the one or more memory stacks via the connection circuitry, wherein each interposer die of the one or more interposer dies is configured to concurrently support two or more compute dies.

10. The processing system of claim 9, wherein an interposer die of the one or more interposer dies includes interconnection circuitry configured to communicatively couple the AU to the memory using a communication protocol.

11. The processing system of claim 10, wherein the communication protocol comprises peripheral component interconnect express (PCIe) protocols.

12. The processing system of claim 9, wherein an interposer die of the one or more interposer dies is configured to concurrently support a compute die having a first type and a compute die having a second type, wherein the first type is different from the second type.

13. The processing system of claim 12, wherein the interposer die of the one or more interposer dies includes a first set of circuitry to support the compute die having the first type and a second set of circuitry to support the compute die having the second type, wherein the first set of circuitry is different from the second set of circuitry.

14. The processing system of claim 9, wherein the one or more interposer dies are disposed on the connection circuitry such that each interposer die of the one or more interposer dies is communicatively coupled to one or more other interposer dies.

15. The processing system of claim 12 wherein the AU includes a set of registers configured to set one or more partitions of the AU, wherein a partition of the one or more partitions includes at least one compute die of the AU.

16. An accelerator unit (AU), comprising:
one or more memory stacks disposed on a connection circuitry;
an interposer die disposed on the connection circuitry such that the interposer die is communicatively coupled to the one or more memory stacks via the connection circuitry;
one or more compute dies disposed on the interposer die; and
one or more partitions each including a respective compute die of the one or more compute dies and a respective memory stack of the one or more memory stacks.

17. The AU of claim 16, further comprising set of registers configured to set the one or more partitions.

18. The AU of claim 16, wherein the one or more compute dies includes a compute die of a first type and a compute die of a second type that is different from the first type.

19. The AU of claim 18, wherein the interposer die includes a first set of circuitry to support the compute die of the first type and a second set of circuitry to support the compute die of the second type, wherein the first set of circuitry is different from the second set of circuitry.

20. The AU of claim 16, wherein the interposer die is disposed on the connection circuitry such that the interposer die is communicatively coupled to one or more other interposer dies.
